(19) United States
(12) Patent Application Publication
(10) Pub. No.: US 2026/0299999 A1
(43) Pub. Date: Oct. 1, 2026

(54) MULTI-AGENT FAILURE DETECTION

(71) Applicant: Cisco Technology, Inc., San Jose, CA (US)

(72) Inventors: Charles Fleming, Oxford, MS (US); Ramana Rao V.R. Kompella, Foster City, CA (US); Jayanth Srinivasa, Newark, CA (US); Gaowen Liu, Naperville, IL (US)

(73) Assignee: Cisco Technology, Inc., San Jose, CA (US)

(21) Appl. No.: 19/091,206

(22) Filed: Mar. 26, 2025

(51) Int. Cl. G06F 9/48; G06F 9/451

(52) U.S. Cl. CPC G06F 9/4881; G06F 9/451

(57) ABSTRACT

In one implementation, a device represents a task execution plan for an agentic system to complete a task as a call graph, the agentic system comprising a plurality of artificial intelligence-based agents that cooperate to complete the task according to the task execution plan. The device converts the call graph into a call graph embedding. The device uses an artificial intelligence model to make an assessment as to whether the agentic system will successfully complete the task based on the call graph embedding. The device provides an indication of the assessment.

### TECHNICAL FIELD

The present disclosure relates generally to artificial intelligence (AI)-based agents and, more particularly, to multi-agent failure detection.

### BACKGROUND

The recent breakthroughs in large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

However, there is often little to no visibility into the interactions between agents in a multi-agent system. Indeed, most agentic systems rely on loosely defined structures (e.g., group chat, manager workers, etc.), making their task executions non-interpretable (e.g., due to lengthy chats between agents, etc.). Additionally, task runs are independent of one another, due to the stochastic nature of LLMs.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIGS. 5A-5B illustrate an example of a multi-agent system;

FIG. 6 illustrates an example of multi-agent failure detection; and

FIG. 7 illustrates an example simplified procedure for multi-agent failure detection, in accordance with one or more implementations described herein.

### DESCRIPTION OF EXAMPLE IMPLEMENTATIONS

### Overview

According to one or more implementations of the disclosure, a device represents a task execution plan for an agentic system to complete a task as a call graph, the agentic system comprising a plurality of artificial intelligence-based agents that cooperate to complete the task according to the task execution plan. The device converts the call graph into a call graph embedding. The device uses an artificial intelligence model to make an assessment as to whether the agentic system will successfully complete the task based on the call graph embedding. The device provides an indication of the assessment.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

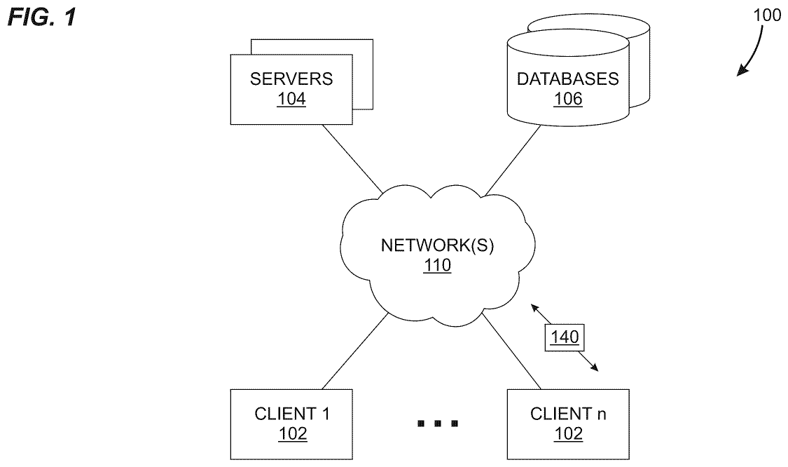

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

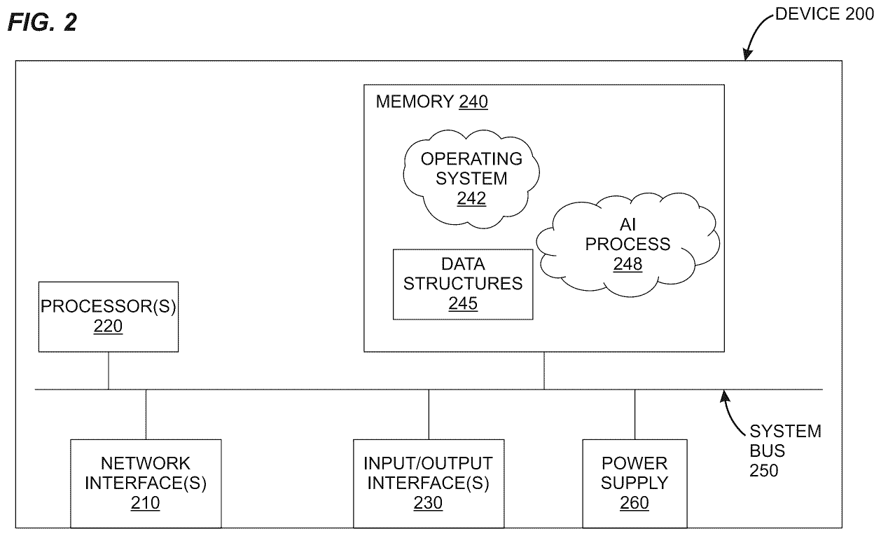

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

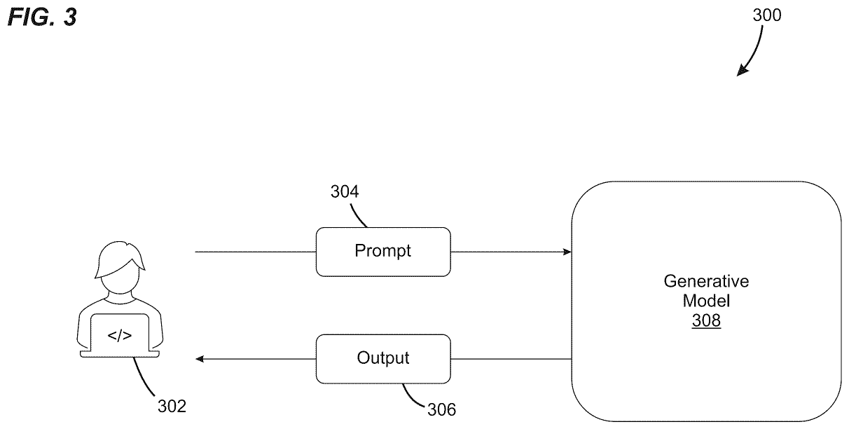

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

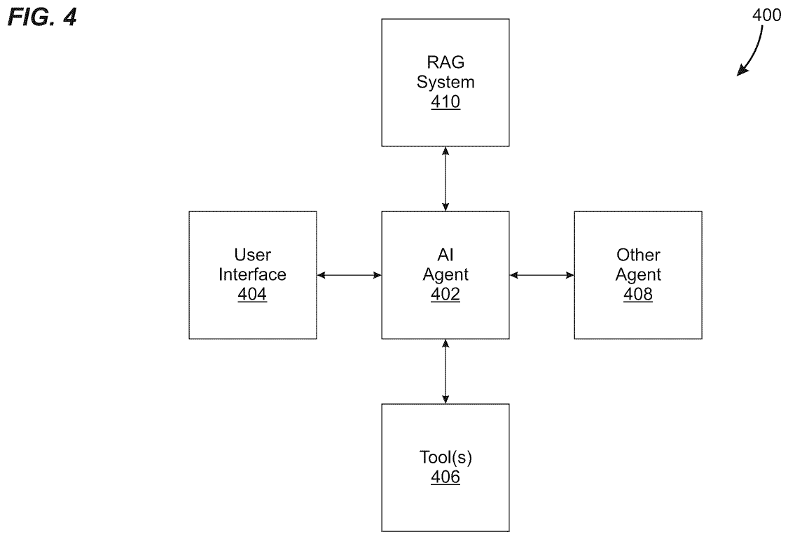

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, agentic systems present an evolution over singular AI-agents as they are able to perform complex tasks by chaining multiple calls to one or more LLMs. Indeed, agentic systems also allow for different AI-based agents to be specialized for different (sub)tasks. However, agentic systems that include multiple AI-based agents still suffer from low accuracy with respect to task planning. Indeed, many modern AI models, such as LLMs, rarely break 80% accuracy with respect to task planning, even for simple tasks such as travel planning. As the number of agents increases, so too does the probability of at least one agent failing to properly complete its (sub-)task.

Identifying which agent failed in a multi-agent system, if any, can be challenging. Indeed, visibility into how the AI-agents interact with one another is often lacking in multi-agent systems. This is particularly true in scenarios in which an agent did not return an error but simply took the wrong action.

### Multi-Agent Failure Detection

The techniques herein allow for the detection of failures in agentic systems in which multiple AI-based agents operate in conjunction with one another to perform a task. In some aspects, the techniques herein convert the call graph for the task into an embedding and, in turn, use an AI model trained on its embedding space, to identify a point of failure in the task execution.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device represents a task execution plan for an agentic system to complete a task as a call graph, the agentic system comprising a plurality of artificial intelligence-based agents that cooperate to complete the task according to the task execution plan. The device converts the call graph into a call graph embedding. The device uses an artificial intelligence model to make an assessment as to whether the agentic system will successfully complete the task based on the call graph embedding. The device provides an indication of the assessment.

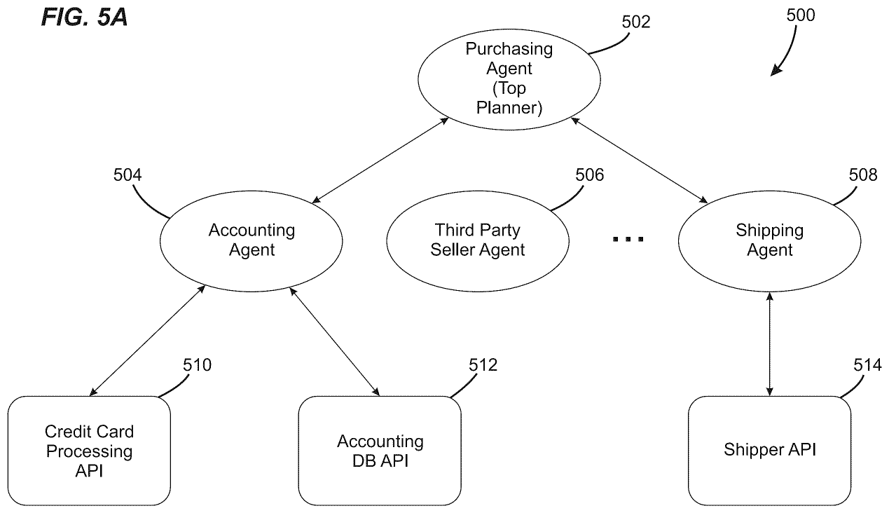

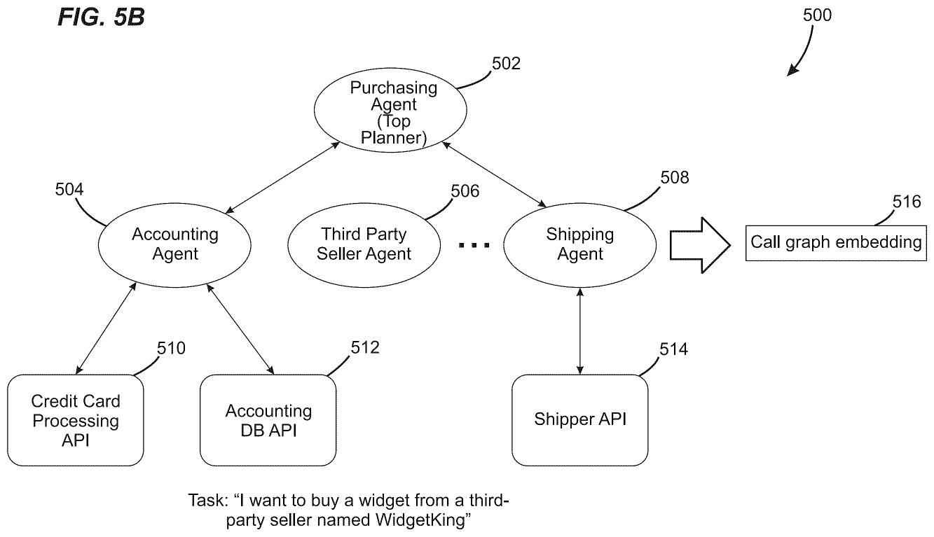

Operationally, FIGS. 5A-5B illustrate an example of a multi-agent system 500, according to various implementations. As shown, assume that multi-agent system 500 includes a plurality of AI-based agents, such as agent 502, agent 504, agent 506, agent 508, and the like.

Each of the agents shown may be configured to perform specialized, discrete operations. To do so, each agent may have a specific set of tools, may use specialized AI models, etc., to achieve their respective functionalities.

For instance, agent 502 may be configured as a purchasing agent that is capable of operating as the top planner agent in multi-agent system 500 for purposes of completing a purchasing task. Agent 504, meanwhile, may be configured as an accounting agent that is responsible for handling the accounting aspects of a purchase. To do so, agent 504 may include tools to interact with various accounting-related APIs such as a credit card processing API 510, an accounting database (DB) API 512, or the like. Agent 506 may be configured as a third-party seller agent to interact with one or more third party sellers using its tools. Finally, agent 508 may be configured as a shipping agent that includes tools to interact with a shipper, such as via shipper API 514.

As would be appreciated, the specific use case of completing an online purchase shown with respect to multi-agent system 500 is for illustrative purposes. Indeed, multi-agent systems can be constructed to perform any number of different types of tasks across a wide variety of use cases and the techniques herein are agnostic as to the specific types of tasks that the agentic system performs. For instance, other example use cases include, but are not limited to, monitoring and/or controlling a computer system or network, performing healthcare diagnostics, home automation, scheduling conferences, or the like.

By way of example, consider the case in which the task that multi-agent system 500 is to perform entails purchasing item X from a third-party seller. In such a case, the purchasing agent, agent 502, may begin by constructing a task execution plan with the following steps:
1. The accounting agent, agent 504, should first process the desired purchase.
2. Then, the third-party seller agent, agent 506, should notify the third-party seller of the desired purchase.
3. Finally, the shipping agent, agent 508, should initiate shipping of item X to the purchaser.

To generate an execute the above task execution plan, agent 502 may have access to a set of resources (other agents and API services) and take as input the desired task (e.g., to make a first party purchase of a particular good or service). In some implementations, agent 502 may simply maintain a list of available agents within multi-agent system 500, such as agents 504-508. In other implementations, agent 502 may instead discover the available agents dynamically, such as by polling agents 504-508 for their capabilities, availability, etc. Once agent 502 has discovered the available agents in agent 502, it may split the overall task into subtasks that it hands off to the other agents. In turn, the selected agents may operate in a similar manner to complete their designated sub-tasks (e.g., by identifying any agents or APIs that they may leverage).

For instance, once agent 502 has formulated the execution plan, it may execute it by interacting with the other respective agents in multi-agent system 500. For each step of the task execution plan, the responsible agent may itself formulate its own set of steps to complete that step. For example, agent 504 may formulate and execute the following, to process the desired purchase:
1. Process the credit card transaction by interacting with credit card processing API 510.
2. Update the accounting database to record the purchase by interacting with API 512.

To complete its own step of the task execution plan, agent 506 may itself formulate and execute the following:
1. Verify the transaction by interacting with API 512.
2. Email the seller (e.g., by interacting with a further API not shown).

Finally, to complete the shipping step of the task execution plan, agent 508 may formulate and execute the following:
1. Transmit shipping information to the seller by interacting with shipper API 514.

As noted above, though, real-world task planning can be challenging for many AI models and, consequently, for AI-based agentic systems. Even for simple tasks such as travel planning, state of the art LLMs rarely break 80% accuracy and do even worse with constraints. Even if the accuracy of the model were to increase significantly, though, the collaboration of agents in a multi-agent system also presents another potential point of failure.

More specifically, the probability of at least one agent failing in a multi-agent system with N agents is 1−P(agent failure)N, where P(agent failure) is the probability of a given agent failing to complete its assigned task. Even if the underlying AI model(s) that the agents use exhibit a 98% accuracy, this translates to approximately an 18% chance of at least one agent failing in a collaborative system with ten agents.

Thus, assuming that model failure rates can be mitigated against, the non-deterministic nature of LLMs and the open-endedness of the tasks being performed mean that planning failures will still occur within a multi-agent system. In some cases, these failures may result in errors that can be reported back to the calling agent and potentially passed on to the user. However, another type of failure is also possible whereby the selected agent successfully completes its (sub)task, but simply did the wrong thing. These types of failures are far more subtle and difficult to identify, particular when there is limited observability into the full task execution plan or when the system includes third-party hosted agents.

According to various implementations, to identify failures in the agentic system, the techniques herein represent the interactions between the agents as a call graph. Such a call graph may, for instance, represent agents, APIs, or other resources as nodes within the call graph and calls made to such resources as edges within the call graph. For instance, a call graph for the above task execution plan may represent agent 504 as a node and, represent credit card processing API 510 as a separate node, and represent agent 504 calling credit card processing API 510 as an edge between the two nodes.

Various approaches can be taken to capture the information used to generate the call graph. In one instance, a network observability platform may monitor and analyze the traffic between agents 502-508, to capture such information. In further cases, an application monitoring platform may leverage code instrumentation to generate telemetry regarding the execution of agents 502-508. Such information could take the form of OpenTelemetry data, for instance.

Once the system has formulated the call graph that represents how the agents will perform or have performed a given task, it may convert this graph into a graph embedding that is a vectorized representation of the graph. For instance, consider the case shown in FIG. 5B whereby the specific task that multi-agent system 500 is to perform is “I want to buy a widget from a third-party seller named WidgetKing.” In such a case, the system may represent the full task execution plan as a call graph and convert that graph into call graph embedding 516.

As would be appreciated, multimodal AI models are models that combine data in two or more modalities. For example, vision-language models accept both text and image inputs. Multimodal models allow the LLM or other model to reason about data in all of its supported modalities. For example, a vision-language model could take as input both a picture of a cat and a textual query of “what color is this cat?” In turn, the model may return “gray” as its answer, after performing image analysis on the picture.

In various implementations, the techniques herein leverage a multimodal model that comprehends both text and graph embedding modalities. Training of the model may be similar to that of vision-language models. However, if traces are unavailable from multi-agent systems in actual use, synthetic training data could also be used. Typically, the training data will include the task execution plan and the sub-plans in the form of graph embeddings of the corresponding call graph.

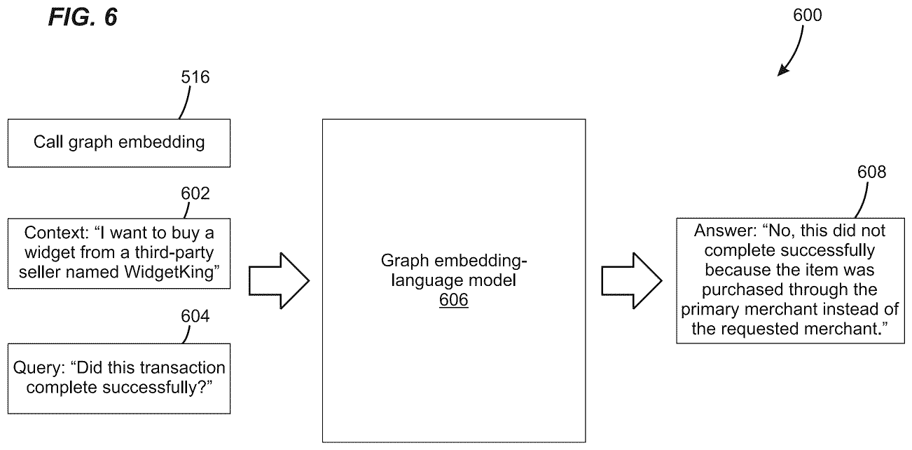

FIG. 6 illustrates an example 600 of multi-agent failure detection, according to various implementations. Continuing the example of FIG. 5B, once the system has generated call graph embedding 516, it may send these embeddings as input to a graph embedding-language model 606. Such a model may be trained using graph embeddings of task execution plans of one or more multi-agent systems, thereby allowing it to identify potential failures within any given call graph, including failures whereby an agent simply takes the wrong action. For instance, in the case of FIG. 5B, assume that multi-agent system 500 make the purchase through the wrong seller. Although the transaction may have completed from an error standpoint, this can still be seen as a failure as it failed to complete the desired task.

In conjunction with call graph embedding 516, the system may also provide a prompt 604 as input to graph embedding-language model 606 asking it to evaluate whether call graph embedding 516 represents a successful plan to complete the task. For instance, prompt 604 may take the form of “did this transaction complete successfully?” In other cases, prompt 604 may posit other questions, such as “why did this transaction fail?”

In one implementation, the system may also provide context 602 in conjunction with call graph embedding 516 and prompt 604 as input to graph embedding-language model 606 as well. For instance, context 602 may take the form of the original prompt, task, or other input to the multi-agent system. In the case of FIGS. 5A-5B, for example, context 602 may take the form of “I want to buy a widget from a third-party seller named WidgetKing.”

Based on its analysis, graph embedding-language model 606 may return an answer 608 to prompt 604. For instance, in the above example, graph embedding-language model 606 may return the answer “no, this did not complete successfully because the item was purchased through the primary merchant instead of the requested merchant.” In various implementations, graph embedding-language model 606 may provide an indication of answer 608 to a user interface, back to the multi-agent system as feedback for future task planning, or the like.

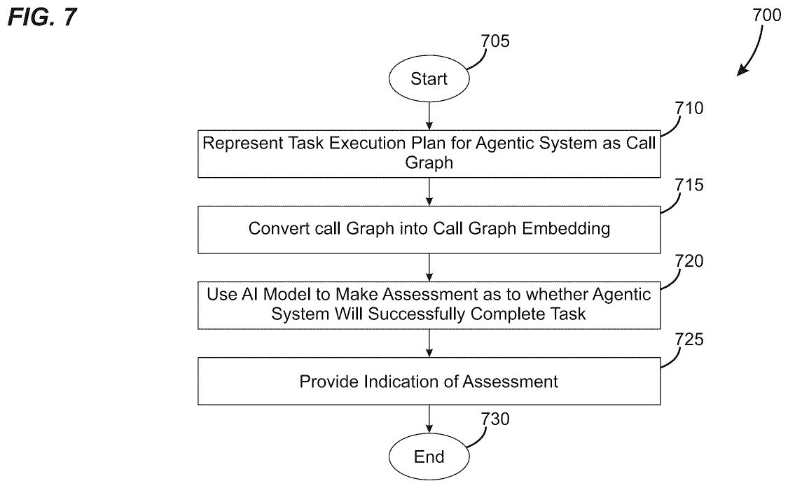

FIG. 7 illustrates an example simplified procedure for multi-agent failure detection, in accordance with one or more implementations described herein. For example, a non-generic, specifically configured device (e.g., device 200), may perform procedure 700 (e.g., a method) by executing stored instructions (e.g., AI process 248). The procedure 700 may start at step 705, and continues to step 610, where, as described in greater detail above, the device (e.g., a controller, server, etc.) may represent a task execution plan for an agentic system to complete a task as a call graph, the agentic system comprising a plurality of artificial intelligence-based agents that cooperate to complete the task according to the task execution plan. In some implementations, agents in the plurality of artificial intelligence-based agents are configured to perform different actions from one another. In one implementation, at least one of the plurality of artificial intelligence-based agents uses a large language model (LLM) to perform its actions.

At step 715, as detailed above, the device may convert the call graph into a call graph embedding. For instance, the device may vectorize the call graph into a vector representation. In some implementations, the call graph indicates at least one function or application programming interface (API) call to be made by a particular one of the plurality of artificial intelligence-based agents according to the task execution plan.

At step 720, the device may use an artificial intelligence model to make an assessment as to whether the agentic system will successfully complete the task based on the call graph embedding, as described in greater detail above. In various implementations, the artificial intelligence model is a multimodal model that comprehends both text and graph embedding modalities. In some implementations, the device may use the artificial intelligence model by using the call graph embedding and a text-based prompt as input to the artificial intelligence model, wherein the text-based prompt includes contextual information regarding the task. In such a case, the text-based prompt may include contextual information regarding the task. For instance, the contextual information may be indicative of a desired outcome for at least one action to complete the task. In some instances, the assessment indicates that the agentic system will not successfully complete the task because a particular one of the plurality of artificial intelligence-based agents will perform an incorrect action.

At step 725, as detailed above, the device may provide an indication of the assessment. In one implementation, the device provides the indication of the assessment to a user interface. In a further implementation, the device provides the indication of the assessment to the agentic system and the agentic system updates the task execution plan based on the indication of the assessment.

Procedure 700 may then end at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for multi-agent failure detection, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
representing, by a device, a task execution plan for an agentic system to complete a task as a call graph, the agentic system comprising a plurality of artificial intelligence-based agents that cooperate to complete the task according to the task execution plan;
converting, by the device, the call graph into a call graph embedding;
using, by the device, an artificial intelligence model to make an assessment as to whether the agentic system will successfully complete the task based on the call graph embedding; and
providing, by the device, an indication of the assessment.

2. The method as in claim 1, wherein the device provides the indication of the assessment to a user interface.

3. The method as in claim 1, wherein the device provides the indication of the assessment to the agentic system and the agentic system updates the task execution plan based on the indication of the assessment.

4. The method as in claim 1, wherein the artificial intelligence model is a multimodal model that comprehends both text and graph embedding modalities.

5. The method as in claim 1, wherein using artificial intelligence model to make the assessment as to whether the agentic system will successfully complete the task comprises:
using the call graph embedding and a text-based prompt as input to the artificial intelligence model, wherein the text-based prompt includes contextual information regarding the task.

6. The method as in claim 5, wherein the contextual information is indicative of a desired outcome for at least one action to complete the task.

7. The method as in claim 1, wherein agents in the plurality of artificial intelligence-based agents are configured to perform different actions from one another.

8. The method as in claim 1, wherein the assessment indicates that the agentic system will not successfully complete the task because a particular one of the plurality of artificial intelligence-based agents will perform an incorrect action.

9. The method as in claim 1, wherein the call graph indicates at least one function or application programming interface (API) call to be made by a particular one of the plurality of artificial intelligence-based agents according to the task execution plan.

10. The method as in claim 1, wherein at least one of the plurality of artificial intelligence-based agents uses a large language model (LLM) to perform its actions.

11. An apparatus, comprising:
one or more network interfaces;
a processor coupled to the one or more network interfaces and configured to execute one or more processes; and
a memory configured to store a process that is executable by the processor, the process when executed configured to:
represent a task execution plan for an agentic system to complete a task as a call graph, the agentic system comprising a plurality of artificial intelligence-based agents that cooperate to complete the task according to the task execution plan;
convert the call graph into a call graph embedding;
use an artificial intelligence model to make an assessment as to whether the agentic system will successfully complete the task based on the call graph embedding; and
provide an indication of the assessment.

12. The apparatus as in claim 11, wherein the apparatus provides the indication of the assessment to a user interface.

13. The apparatus as in claim 11, wherein the apparatus provides the indication of the assessment to the agentic system and the agentic system updates the task execution plan based on the indication of the assessment.

14. The apparatus as in claim 11, wherein the artificial intelligence model is a multimodal model that comprehends both text and graph embedding modalities.

15. The apparatus as in claim 11, wherein the apparatus uses the artificial intelligence model to make the assessment as to whether the agentic system will successfully complete the task by:
using the call graph embedding and a text-based prompt as input to the artificial intelligence model, wherein the text-based prompt includes contextual information regarding the task.

16. The apparatus as in claim 15, wherein the contextual information is indicative of a desired outcome for at least one action to complete the task.

17. The apparatus as in claim 11, wherein agents in the plurality of artificial intelligence-based agents are configured to perform different actions from one another.

18. The apparatus as in claim 11, wherein the assessment indicates that the agentic system will not successfully complete the task because a particular one of the plurality of artificial intelligence-based agents will perform an incorrect action.

19. The apparatus as in claim 11, wherein the call graph indicates at least one function or application programming interface (API) call to be made by a particular one of the plurality of artificial intelligence-based agents according to the task execution plan.

20. A tangible, non-transitory, computer-readable medium storing program instructions that cause a device to execute a process comprising:
representing, by the device, a task execution plan for an agentic system to complete a task as a call graph, the agentic system comprising a plurality of artificial intelligence-based agents that cooperate to complete the task according to the task execution plan;
converting, by the device, the call graph into a call graph embedding;
using, by the device, an artificial intelligence model to make an assessment as to whether the agentic system will successfully complete the task based on the call graph embedding; and
providing, by the device, an indication of the assessment.
